(19) United States
(12) Patent Application Publication
(10) Pub. No.: US 2021/0136723 A1
(43) Pub. Date: May 6, 2021

(54) METHOD AND SYSTEM FOR CLASSIFYING SPEED OF A USER EQUIPMENT

(71) Applicants: INDIAN INSTITUTE OF TECHNOLOGY HYDERABAD, Sangareddy (IN); WISIG NETWORKS PRIVATE LIMITED, Hyderabad (IN)

(72) Inventors: Kiran Kumar Kuchi, Hyderabad (IN); Sibgath Ali Khan Makandar, Sangareddy (IN); Saidhiraj Amuru, Hyderabad (IN)

(21) Appl. No.: 17/257,967

(22) PCT Filed: Jul. 27, 2019
(86) PCT No.: PCT/IN2019/050554

§ 371 Date: Jan. 5, 2021

(30) Foreign Application Priority Data
Jul. 28, 2018 (IN) 201841028421

(51) Int. Cl. H04W 64/00; G01S 11/10

(52) U.S. Cl. CPC H04W 64/006; G01S 11/10

(57) ABSTRACT

Embodiments of the present disclosure are related to system and method of classifying speed of at least one user equipment (UE). The method comprises receiving a plurality of input signals associated with the at least one UE. Also, method comprises estimating a plurality of channels using a plurality of reference signals associated with the inputs signals. Further, the method comprises computing a metric between the estimated plurality of channels and classifying speed of the at least one UE using the computed metric. The classifying the at least one UE using the metric comprises obtaining a power spectral density (PSD) from the metric, estimating a Doppler spectrum width using the PSD and classifying the at least one UE by comparing the Doppler spectrum width with one or more threshold values.

### CROSS-REFERENCE TO RELATED APPLICATIONS

This application claims priority from Indian Provisional Patent Application Number 201841028421, filed on Jul. 28, 2018, the entirety of which are hereby incorporated by reference.

### TECHNICAL FIELD

Embodiments of the present disclosure are related, in general to communication, but exclusively relate to a communication systems and methods for estimating user equipment (UE) speed and classifying the UE as low, medium or high speed.

### BACKGROUND

Generally, different users of mobile device or user equipment (UE) move at different speeds in a wireless cellular deployment. For example, along the highways users move at very high speeds in the range of 70 kmph to 120 kmph, while within urban areas the speeds are typically limited to 50 kmph, and within indoors i.e. inside buildings the users are mostly static. Different scheduling strategies needs to be used for different types of users. For instance, when the users are moving at higher speeds, the corresponding channel state information feedback obtained from the users rapidly goes stale and cannot be used reliably for scheduling. Hence, new information is required quite frequently to perform high throughput scheduling, such as MIMO, for these UEs. However, if the information associated with a user is known i.e. moving fast, then open loop MIMO strategies such as transmit diversity may be used and still enhance throughputs for these UEs. Such speed classification techniques also help in user pairing algorithms wherein users with similar characteristics may be paired to perform multi-user MIMO scheduling. Further, the information helps in enhancing the handover performance as the base station can anticipate that the user will experience handovers at a particular time and coordinate with the target base station to avoid any data connection failures.

By estimating the UE speed correctly, the Doppler spread that the user may experience is estimated, which can then be compensated when receiving signals from the user, in the uplink. The effect of carrier frequency offset should also be taken into account when designing such applications. The application may work well independent of the carrier frequency offsets (CFO), when relied on the physical characteristics of the Doppler spectrum behavior. Specifically, when the UE is moving at a speed ‘ν’ kmph, the maximum induced Doppler is given by fₘ=ν/λ wherein λ is the wavelength of the wireless signals used for communication.

The FIG. 1 shows Jakes model based Doppler spectrum, in accordance with a prior art. For simulations, and for representing the wireless channel effects in a realistic manner, the effect of Doppler is typically generated using Jakes model of the channel generation, which generates a Doppler spectrum. As shown in FIG. 1, f_{c} is the carrier frequency used for communication, fₘ is the maximum Doppler frequency induced by the movement between the transmitter and receiver. The U-shaped bowl spectrum is an indicator of the set of frequencies that get induced by the effect of Doppler. The spectrum as shown in FIG. 1, needs to be estimated at the receiver in order to estimate the Doppler induced between the transmitter and the receiver.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In an aspect of the present disclosure, a method of classifying speed of at least one user equipment (UE) is provided. The method comprises receiving, by a communication system, a plurality of input signals associated with the at least one UE. Also, method comprises estimating a plurality of channels using a plurality of reference signals associated with the inputs signals. Further, the method comprises computing a metric between the estimated plurality of channels and classifying speed of the at least one UE using the computed metric.

Another aspect of the present disclosure is a communication system to classify speed of at least one user equipment (UE). The communication system comprises an input unit, a channel estimator, a filter and a classifier. The input unit receives a plurality of input signals associated with the at least one UE. The channel estimator estimates a plurality of channels using a plurality of reference signals associated with the inputs signals. The filter computes a metric between the estimated plurality of channels. The classifier classifies speed of the at least one UE using the computed metric.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1 shows an illustration of Jakes model based doppler spectrum, in accordance with a prior art;

FIG. 2 shows a block diagram of a communication system for estimating user equipment (UE) speed and classifying the UE, in accordance with an embodiment of the present disclosure;

FIG. 3 shows a flowchart illustrating a method of estimating the UE speed and classifying the UE, in accordance with an embodiment of the present disclosure;

FIG. 4 shows a plot illustrating power spectral density (PSD) in low, medium and high Doppler scenarios, in accordance with an embodiment of the present disclosure;

FIG. 5 shows a plot illustrating probability of correct user speed classification, in accordance with an embodiment of the present disclosure;

FIG. 6 shows an illustration of classifying users using the communication system of FIG. 2, in accordance with an embodiment of the present disclosure;

FIG. 7 shows a block diagram of a communication system for estimating user equipment (UE) speed, in accordance with another embodiment of the present disclosure;

FIG. 8 shows a flowchart illustrating a method of classifying speed of a UE, in accordance with another embodiment of the present disclosure; and

FIGS. 9 and 10 shows plots illustrating performance results of estimating the UE speed for a multi-tap channel at 0 dB SNR, in accordance with an embodiment of the present disclosure.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

Embodiments of the present disclosure relate to a communication system and method for estimating user equipment (UE) speed and classifying the UE based on the estimated speed. The method comprises receiving, by a communication system, a plurality of input signals associated with the at least one UE. Also, method comprises estimating a plurality of channels using a plurality of reference signals associated with the inputs signals. Further, the method comprises computing a metric between the estimated plurality of channels and classifying speed of the at least one UE using the computed metric.

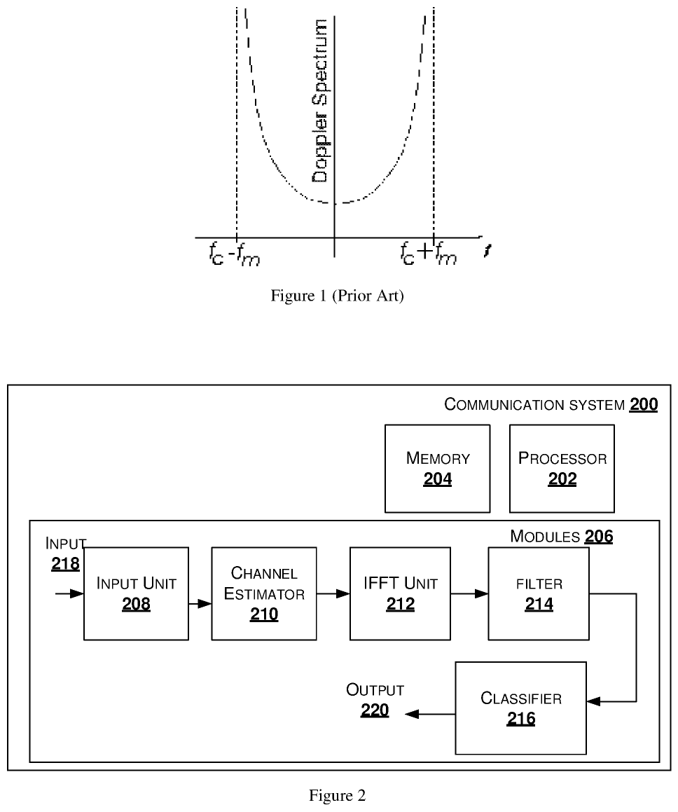

FIG. 2 shows a block diagram of a communication system for estimating user equipment (UE) speed and classifying the UE, in accordance with an embodiment of the present disclosure.

As shown in FIG. 2, the communication system 200, also referred as a base station (BS), comprises a processor 202, a memory 204 and a plurality of modules 206. The memory 204 may be communicatively coupled to the processor 202. The processor 202 may be configured to perform one or more functions of the communication system 200 such as, but not limited to transmitting, receiving signals, estimating UE speed and classifying the UE as one of low speed, medium speed or high speed. In one implementation, the communication system 200 may comprise blocks or units or modules 206 for performing various operations in accordance with the embodiments of the present disclosure.

The communication system, hereinafter referred as system or BS 200, is configured to use a plurality of reference signals such as, but not limited to demodulation reference signals (DMRS) and sounding reference signals (SRS) in the uplink. First time when a user equipment (UE) transmits a PRACH and PUSCH in Msg3, the BS obtains the UE speed and initiates scheduling the UE, right after initial access with the appropriate scheduling transmission mode for enhancing the system throughput.

The modules 206 include an input unit 208, channel estimator 210, Inverse Fast Fourier transform (IFFT) unit 212, a Doppler filter 214 and a classifier 216. In an embodiment, the system 200 is independent of the carrier frequency offsets (CFO) induced by the receiver or a residual CFO that remains between the user and the base station. The input unit 208, configured in the BS 200, receives input signals 218. The input signals 218 are a plurality of reference signals from at least one user equipment, which are at least one of demodulation reference signals (DMRS) and sounding reference signals (SRS). The at least one user equipment is scheduled with an uplink transmission (PUCCH/PUSCH).

The channel estimator 210, also referred as channel estimation unit or estimator or estimation module, estimates a plurality of channels using the received reference signals, associated with the input signals and obtain the frequency domain channel estimates.

The IFFT unit 212, configured in the communication system 200, converts the estimated plurality of channels, which is typically the case ion OFDM systems, from frequency domain in to time domain of a predefined size. Let, the estimated time domain signal is denoted as hₜ at time −t. Estimating the time-domain correlation for the obtained time domain estimates as 1/LΣₗ₌₀^{L}hₜ(l)h*_{{t+τ}}(l) where l is the tap index of a L-tap channel and h*_{{t+τ}} is the complex conjugate of the channel at time t+τ.

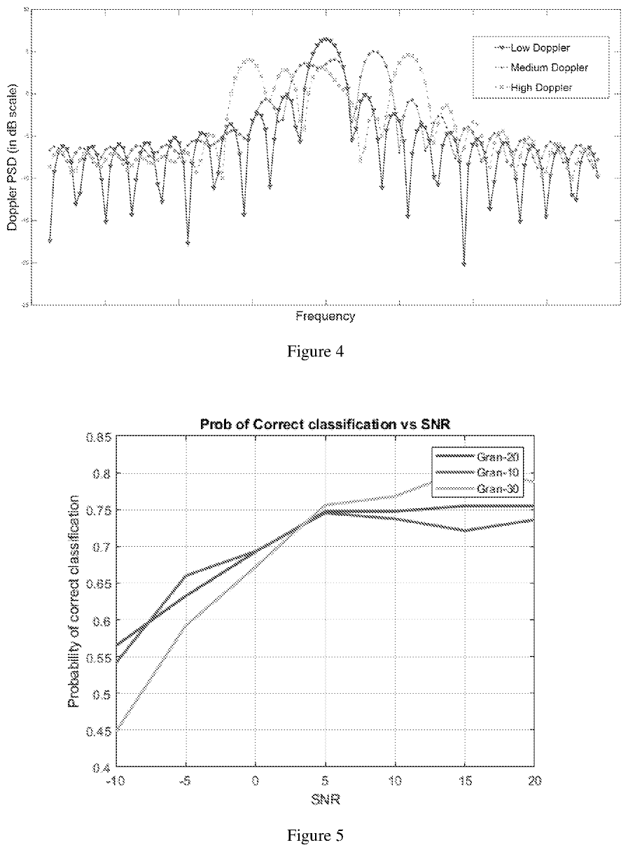

The filter 214, also referred as Doppler filter configured in the communication system 200, computes a metric between the estimated plurality of channels. The metric is also referred as a correlation metric or cross correlation metric. The computation of metric comprises obtaining cross correlation on the estimated plurality of channels to obtain a metric, normalizing value of the metric and applying Fourier transform on the normalized metric to obtain a power spectral density (PSD). FIG. 4 illustrates plots for the PSD for different UE speeds. As shown in the FIG. 4, the spread of the spectrum changes based on the UE speed.

The classifier 216, also referred as a classification unit or classification module, speed of the at least one UE using the computed metric. The classifier estimates zero crossings and associated length of zero crossing on the PSD, which is an indicator for the Doppler spread or the UE speed. Thus, estimating the spread of the Doppler spectrum, which is above a threshold, for example 10, 10 to 35 and above 35. The classifier 216 classifies the user equipment using the estimated doppler spectrum as one of low speed, medium speed and high speed, which is the output 220. For example, if the length of zero crossing on the PSD is less than 10, then the UE speed is classified as low speed. If the length of zero crossing on the PSD is in between 10 and 35 then the UE speed is classified as medium speed. If length of zero crossing on the PSD is above 35 then the UE speed is classified as high speed. Based on the UE speed, the BS decides the scheduling strategies for the user as one of single-user MIMO, multi-user MIMO, single antenna strategies, and transmit diversity.

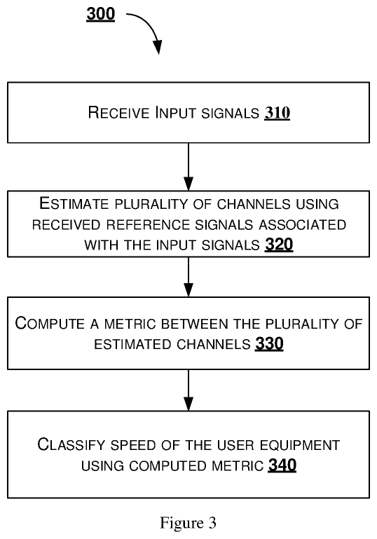

FIG. 3 shows a flowchart illustrating a method of estimating the UE speed and classifying the UE, in accordance with an embodiment of the present disclosure. The method comprises configuring Uplink signals to the users, estimating user speed and classify the users based on the speed as one of low, medium and high speeds. Based on the user speed, the BS decides the scheduling strategies for the user as one of single-user MIMO, multi-user MIMO, single antenna strategies, and transmit diversity.

As illustrated in FIG. 3, the method 300 comprises one or more blocks for method of classifying speed of at least one UE. The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 310, receiving input signals by the input unit 208, configured in the BS 200. The input signals 218 is a plurality of reference signals from a plurality of user equipment's, which are at least one of demodulation reference signals (DMRS) and sounding reference signals (SRS). The plurality of users are schedule users with uplink transmissions (PUCCH/PUSCH).

At block 320, channel estimation is performed by a channel estimator 210, configured in the BS 200, on the reference signal locations and obtain the channel estimates.

At block 330, computing a metric between the plurality of estimated channels using a filter or Doppler filter 214, configured in the communication system 200. The computation of metric comprises obtaining cross correlation on the estimated plurality of channels to obtain a metric, normalizing value of the metric and applying Fourier transform on the normalized metric to obtain a power spectral density (PSD).

At block 340, classifying speed of the user equipment is performed, by the classifier 216, using computed metric. The classifier 216 estimates zero crossings and associated length of zero crossing on the PSD, which is an indicator for the Doppler spread or the UE speed. By estimating the spread of the Doppler spectrum, which is above a threshold, for example for 0 dB as the threshold. Using the estimated Doppler spectrum, the classifier 216 classifies the user equipment as one of low speed, medium speed and high speed. Based on the user equipment speed, the BS decides the scheduling strategies for the user as one of single-user MIMO, multi-user MIMO, single antenna strategies, and transmit diversity.

FIG. 4 shows a plot illustrating power spectral density (PSD) in low, medium and high Doppler scenarios, in accordance with an embodiment of the present disclosure.

As shown in FIG. 4, the results using the communication system 200 or the method 300 of estimating speed of at least one UE and classify the at least one UE. The at least one UE is classified as one of low, medium and high speed users. Also, FIG. 4 shows granularity of the UE speeds on which UEs are classified. For example, the classified users with speeds between 1-120 kmph at the granularity of 10, 20, 30 respectively. In an embodiment, considering that a residual CFO at the user is 100 Hz, the method of estimating the UE speed provides approximately 80% classification accuracy as shown in FIG. 4. The communication system 200 or the method 300 for classifying UE speed is independent of the CFO induced by the communication system, as the method relies on the Doppler spread and not the exact values.

FIG. 5 shows a plot illustrating probability of correct user speed classification, in accordance with an embodiment of the present disclosure. For classification, threshold-based method for identifying the zero crossings is used for classifying the users which is as shown in FIG. 5.

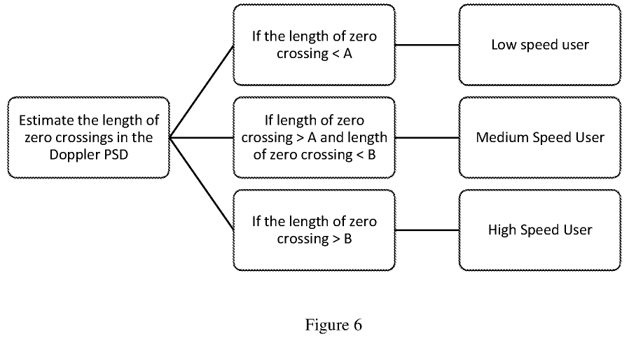

FIG. 6 shows an illustration of classifying users, in accordance with an embodiment of the present disclosure. As shown in FIG. 6, the classifier 216 estimates first length of zero crossings in the Doppler PSD. Thereafter, the length of zero crossing is compared with a threshold or set of threshold values, based on which the user or user equipment speed is classified. For example, if the length of zero crossing is less than a threshold value A, then the user is classified as low speed user. If the length of zero crossing is in between value A and B, then the user is classified as medium speed user. If the length of zero crossing is greater than a value B, then the user is classified as high speed user.

In an embodiment, the communication system 200 or the method 300 is comprises machine learning techniques such that thresholds A, B may be adaptively tuned across various channel models, various scenarios such as highways, urban macro, and the like. Also, the communication system 200 or the method 300 is configured to estimate the central lobe width, which may provide optimized and accurate estimation. In an embodiment, the method may be used for enhancing the classification accuracy and also the classes in which users may be classified as one of very low speed, low speed, medium speed, high speed and very high speed users, which is based on the choice of scheduler, configured in the BS 200.

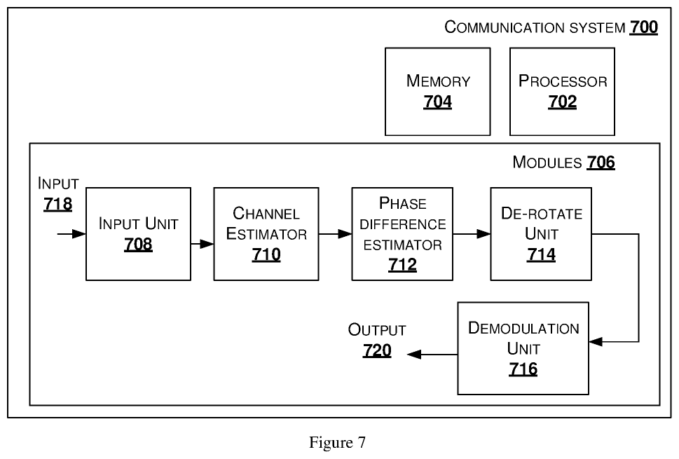

FIG. 7 shows a block diagram of a communication system for classifying speed of at least one user equipment (UE), in accordance with another embodiment of the present disclosure;

As shown in FIG. 7, the communication system 700, also referred as a base station (BS), comprises a processor 702, a memory 704 and a plurality of modules 706. The memory 704 may be communicatively coupled to the processor 702. The processor 702 may be configured to perform one or more functions of the communication system 700 such as, but not limited to transmitting, receiving signals, estimating UE speed and classifying the UE. In one implementation, the communication system 700 may comprise modules 706 for performing various operations in accordance with the embodiments of the present disclosure.

The BS 700 receives an input 718, comprising a plurality of reference signals such as, but not limited to demodulation reference signals (DMRS) and sounding reference signals (SRS). This is for an uplink communication. When a user equipment transmits Physical Random Access Channel (PRACH) and Physical uplink shared channel (PUSCH) in Msg3 to the BS 700, the base station obtains the UE speed and start scheduling the UE. The communication system 700 is configured to estimate channel using the estimated Doppler parameter combined with carrier frequency offsets (CFO).

The modules 706 include an input unit 708, channel estimator 710, phase difference estimator 712, de-rotate unit 714 and demodulation unit 716. In an embodiment, the communication system 700 is configured to estimate channel by estimating the Doppler parameter combined with the CFO.

The input unit 708, configured in the communication system 700 receives an input 718, also referred as input signals. The input 718 is a plurality of reference signals from a plurality of users, which are at least one of demodulation reference signals (DMRS) and sounding reference signals (SRS). The plurality of users are schedule users with uplink transmissions (PUCCH/PUSCH).

The channel estimator 710, also referred as channel estimation module or estimation module, calculates the reference signal resource element locations for OFDM system and extract the channel estimate using one of zero-forcing, MMSE and the like.

The phase difference (PD) estimator 712, also referred as PD estimation module, estimates the phase difference between the obtained channel estimates. The obtained channel estimates are associated with the CFO and Doppler parameter estimation. In an embodiment, the phase difference estimation is the differential phase between tone averaged channel estimates in a PUSCH/PUCCH DMRS within and across a sub frame. The differential phases from all the allocated sub frames are averaged to yield the phase difference which in turn provides an estimate of UEs speed. The following equation is used to obtain the phase difference:

$$Δ f = \frac{1}{{N}_{TTI}} {\sum }_{j = 0}^{{N}_{TTI} - 1} ( ( \frac{1}{{M}_{SC}} {\sum }_{k = 1}^{{M}_{SC}} {H}_{2} ( k ) ) {( \frac{1}{{M}_{SC}} {\sum }_{k = 1}^{{M}_{SC}} {H}_{1} ( k ) )}^{*} )$$

wherein, M_{sc} is the number of sub-carriers used for averaging the channel estimates in frequency domain, N_{TTI} is the time duration (number of sub frames) over which the estimate is averaged, H₁and H₂ are the frequency domain channel estimates on consecutive DMRS or SRS symbol locations. These symbol locations may or may not be adjacent in time domain. In the above equation, the * operator stands for the conjugate operation.

The de-rotation module 714 de-rotates the obtained estimated signals to generate de-rotated signals which is correcting any offsets present in the estimated signals. The demodulation module 716 demodulate the de-rotated signal to generate an output 720 which is the estimate speed associated with the UE. Thereafter, a classifier (not shown in the Figure) classifies the UE using the estimated speed.

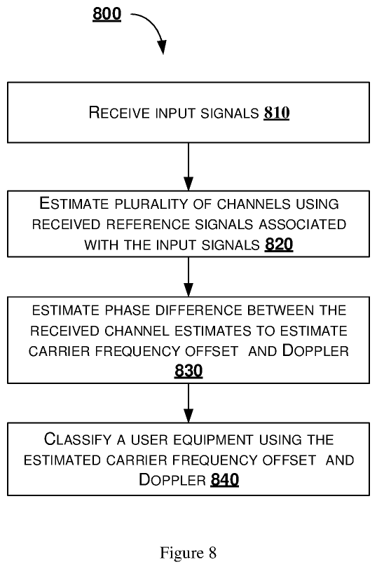

In one embodiment, method of classifying at least one UE by estimating speed comprises estimating the at least one UE speed by obtaining a phase difference between the channel estimates and classifying the speed of the at least one UE as one of low, medium and high based on the estimated speed as shown in FIG. 8.

FIG. 8 shows a flowchart illustrating a method of estimating UE speed, in accordance with another embodiment of the present disclosure. The method comprises configuring Uplink signals to the users, estimating user speed which relies on estimating channel for estimating the Doppler parameter combined with CFO.

As illustrated in FIG. 8, the method 800 comprises one or more blocks for method of estimating UE speed. The order in which the method 800 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 810, receiving input signals 718 by the input unit 708, configured in the BS 700, wherein the input signals 718 is a plurality of reference signals from a plurality of users, which are at least one of demodulation reference signals (DMRS) and sounding reference signals (SRS). The plurality of users are schedule users with uplink transmissions (PUCCH/PUSCH).

At block 820, channel estimation is performed by a channel estimator 710, configured in the BS 700, on the reference signal locations for OFDM system and extracts the channel estimate using one of zero-forcing, MMSE and the like.

At block 830, estimating the phase difference between the obtained channel estimates and relates it to the CFO and Doppler parameter estimation. The phase difference estimation is the differential phase between tone averaged channel estimates in a PUSCH/PUCCH DMRS within and across a sub frame. The differential phases from all the allocated sub frames are averaged to yield the phase difference which in turn provides an estimate of UEs speed. The following equation is used to obtain the phase difference:

$$Δ f = \frac{1}{{N}_{TTI}} {\sum }_{j = 0}^{{N}_{TTI} - 1} ( ( \frac{1}{{M}_{SC}} {\sum }_{k = 1}^{{M}_{SC}} {H}_{2} ( k ) ) {( \frac{1}{{M}_{SC}} {\sum }_{k = 1}^{{M}_{SC}} {H}_{1} ( k ) )}^{*} )$$

wherein, M_{sc} is the number of sub-carriers used for averaging the channel estimates in frequency domain, N_{TTI} is the time duration (number of sub frames) over which the estimate is averaged, H₁ and H₂ are the channel estimates on consecutive DMRS or SRS symbol locations. In the above equation, the * operator stands for the conjugate operation.

At block 840, a classification of the UE, using a classifier configured in the BS 700, from an obtained estimated speed using the estimated phase difference between the plurality of channels.

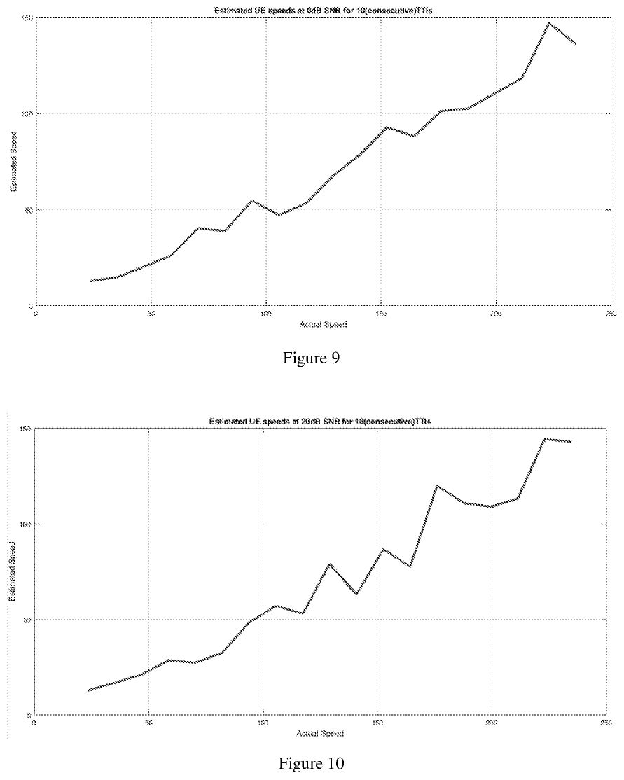

FIGS. 9 and 10 shows plot illustrating performance results for estimating the user speed for a multi-tap channel at 0 dB SNR, in accordance with an embodiment of the present disclosure. The results of the methods as shown in FIG. 8, are shown in FIGS. 6 and 7 for various parameters. As shown in FIGS. 9 and 10, the estimated Δf is converted back to a speed estimate as vₑₛₜᵢₘₐₜₑ=Δf*λ. FIG. 9 illustrated performance of the method of classifying speed of at least one UE. FIG. 8 for estimating the user speed for a multi-tap channel at 0 dB SNR. FIG. 10 shows the performance of the method of FIG. 8 for estimating the user speed for a multi-tap channel at 20 dB SNR.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method of classifying speed of at least one user equipment (UE), the method comprising:
receiving, by a communication system, a plurality of input signals associated with the at least one UE;
estimating, by the communication system, a plurality of channels using a plurality of reference signals associated with the inputs signals;
computing, by the communication system, a metric between the estimated plurality of channels; and
classifying, by the communication system, speed of the at least one 1.1E using the computed metric.

2. The method as claimed in claim 1, wherein the plurality of input signals is at least one of demodulation reference signals (DMRS) and sounding reference signals (SRS).

3. The method as claimed in claim 1, wherein the estimated plurality of channels is converted in to time domain from frequency domain using an inverse Fourier transform.

4. The method as claimed in claim 1, wherein computing the metric between estimated plurality of channels comprises normalizing value of the metric and applying Fourier transform on the normalized metric to obtain the PSD.

5. The method as claimed in claim 1, wherein classifying the at least one UE using the metric comprising:
obtaining a power spectral density (PSD) from the metric;
estimating a Doppler spectrum width using the PSD; and
classifying the at least one UE by comparing the Doppler spectrum width with one or more threshold values.

6. The method as claimed in claim 5, wherein the width of the Doppler spectrum is computed by estimating zero crossing of the Doppler spectrum and determining a length of zero crossing.

7. The method as claimed in claim 1, wherein the at least one UE is classified as one of low speed, medium speed and high speed.

8. The method as claimed in claim 1, wherein classifying the at least one UE using the metric comprising:
estimating the at least one UE speed by obtaining a phase difference between the channel estimates; and
classifying the speed of the at least one UE as one of low, medium and high based on the estimated speed.

9. A communication system to classify speed of at least one user equipment (UE), the communication system comprising:
an input unit to receive a plurality of input signals associated with the at least one UE; a channel estimator to estimate a plurality of channels using a plurality of reference signals associated with the inputs signals;
a filter to compute a metric between the estimated plurality of channels; and a classifier to classify speed of the at least one UE using the computed metric.

10. The system as claimed in claim 9, wherein the plurality of input signals is at least one of demodulation reference signals (DMRS) and sounding reference signals (SRS).

11. The system as claimed in claim 9, wherein the system comprises an inverse Fast Fourier transform unit to convert the estimated plurality of channels in to time domain from frequency domain.

12. The system as claimed in claim 9, wherein the filter is a Doppler filter configured to normalize the metric and transform the normalized metric to obtain the PSD.

13. The system as claimed in claim 9, wherein the classifier unit is configured to:
obtain a power spectral density (PSD) from the metric;
estimate a Doppler spectrum width using the PSD by estimating zero crossing of the Doppler spectrum and determining a length of zero crossing; and
classify the at least one UE by comparing the Doppler spectrum width with one or more threshold values.

14. The system as claimed in claim 9, wherein the at least one UE is classified as one of low speed, medium speed and high speed.

15. The system as claimed in claim 9, wherein the classifier unit is configured to
estimate the at least one UE speed by obtaining a phase difference between the channel estimates; and
classify the speed of the at least one UE as one of low, medium and high based on the estimated speed.
